(19) United States
(12) Patent Application Publication
(10) Pub. No.: US 2017/0323293 A1
(43) Pub. Date: Nov. 9, 2017

(54) Processing Transactions

(71) Applicant: APRICOT SQUARE LTD, London (GB)

(72) Inventor: Tamir Strauss, London (GB)

(73) Assignee: Apricot Square Ltd, London (GB)

(21) Appl. No.: 14/900,991

(22) PCT Filed: Jun. 25, 2014
(86) PCT No.: PCT/GB2014/051939

§ 371 Date: Dec. 22, 2015

(30) Foreign Application Priority Data
Jun. 25, 2013 (GB) 1311269.3

(51) Int. Cl. G06Q 20/38; G06Q 20/36; G06Q 20/22

(52) U.S. Cl. CPC G06Q 20/381; G06Q 20/227; G06Q 20/3676

(57) ABSTRACT

A method for maintaining a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the method comprising the step of: inhibiting the crediting of the balance of a subset of the wallets associated with the plurality of currencies such that the balance for each of said subset of wallets is less than or equal to a predetermined amount irrespective of the currency of credit credited to the multicurrency card.

This application relates to methods and systems for maintaining and managing a multicurrency card to provide improved transaction processing, and for performing transactions using such a card.

Payment cards are tokens bearing information that identifies an underlying account or series of accounts from which payment may be made. Conventionally the token takes the form of a card, but for convenience it could be embodied in other ways, including in software on a device such as a mobile phone. In this document the term “card” will be used to refer to the combination of the token and the underlying account structure irrespective of the physical form (if any) in which the token is embodied. Conventionally the information identifying the underlying account is held in visible form, magnetically encoded form or in the form of a smart card, but it could be held in other ways. Payment cards include credit cards (in which a customer normally refunds the account's operator after a payment has been made through the card) and debit cards (in which a customer normally credits the underlying account before a payment is made through the card). The present invention is applicable to both credit and debit cards.

Multicurrency cards allow customers to credit a single payment card, such as a prepaid cash card, in a number of foreign currencies and use the card to make foreign-currency payments without incurring any foreign exchange (“FX”) fees. A prepaid multicurrency card can have a number of wallets, each wallet being associated with a currency. The multicurrency card may have a base wallet which is associated with a base currency depending on where the card is issued. Each of the other wallets are associated with its own currency that is different to the base currency. For example, if the card is issued in the USA, the base currency would normally be US dollars (USD) and the other foreign currencies and associated wallets may be, for example, Euros (EUR), pounds sterling (GBP) and Australian dollars (AUD). The multicurrency card may have any number of foreign currency wallets. The number of foreign currency wallets may be dependent on which currencies are enabled on the card by the card issuer or by the card scheme.

Each wallet can be credited or debited in the currency that it is associated with. In the example given above, the multicurrency card may be credited with the domestic, base currency (USD) in the base wallet and also with foreign currency into the respective foreign currency wallets (EUR, GBP and/or AUD). The multicurrency card can allow the cardholder to utilise the entire balance of the card to fund a transaction. So if there are insufficient funds available in the transaction currency's wallet, because either it is not one of the available wallets, or because there is insufficient balance in the relevant transaction currency, the processor that processes the transactions may use the available currency balances in the other wallets in an order of priority. Said order can be predefined, modified or set ad-hoc by the card scheme, customer, or other entities involved in the transaction. Using the example above, an order of priority may be 1. USD, 2. EUR, 3. GBP, 4. AUD. This means that the processor will first take funds from the relevant currency balance, i.e. if the transaction in question is in GBP the process will determine if there is a sufficient GBP wallet balance and, if not, will work its way through the balances in the above order until the transaction amount is able to be satisfied, or until all wallets have been examined and it becomes apparent there are insufficient funds to fulfil the transaction. Alternatively, the transaction process may only examine a subset of the available wallets before determining whether the customer has sufficient funds to fulfil the transaction. In this case, a currency conversion fee usually applies each time a currency is used to fund all or part of the transaction that is different to the transaction currency.

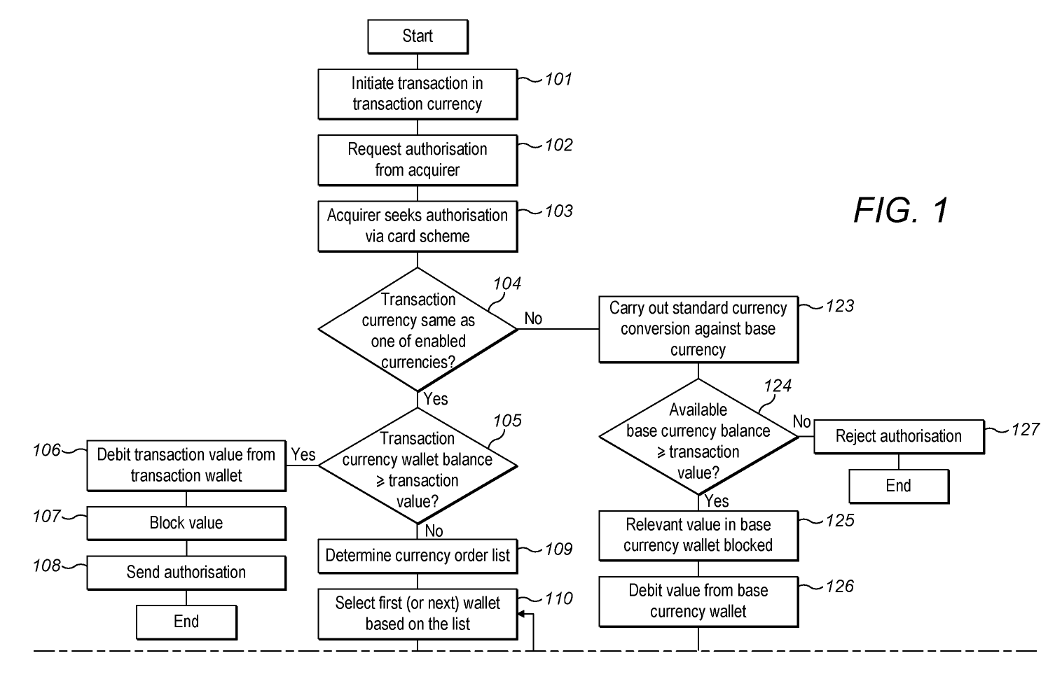

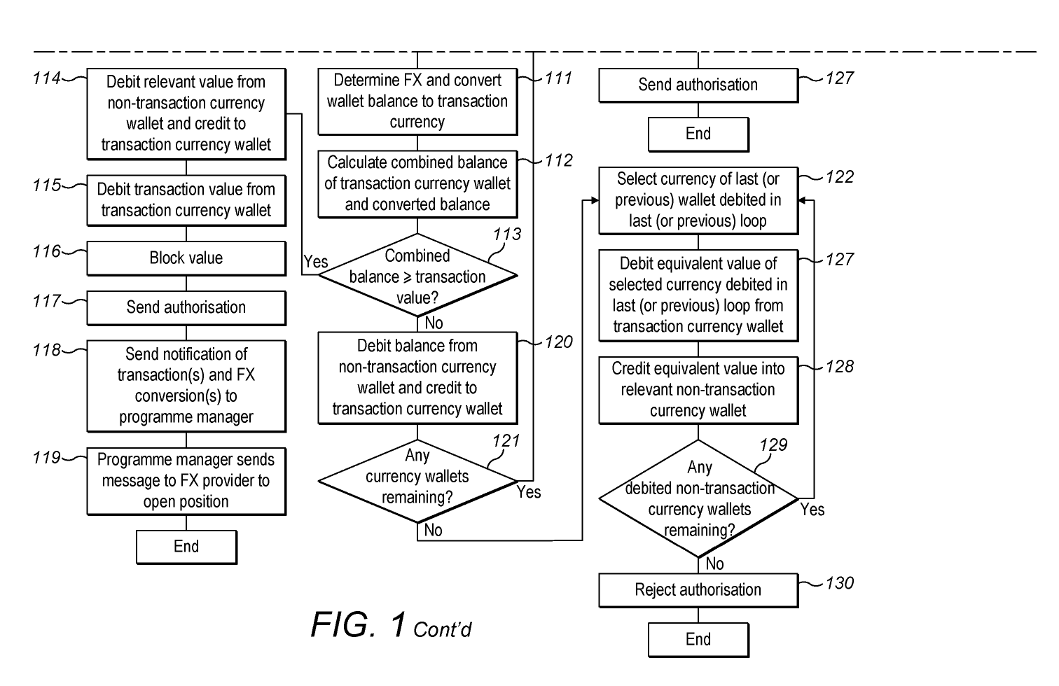

FIG. 1 describes the process in which a transaction can be processed for multicurrency cards. The order of some of the steps described in the process can be changed without affecting the result achieved by the process. Such a process may be defined by the processor, programme manager, programme owner, card scheme or any other entity with the right authority and capabilities.

At step 101, the transaction is initiated at a point-of-sale (POS) terminal in the local, transaction currency of the merchant or acquiring bank.

At step 102, the POS terminal requests authorisation from a relevant acquirer (acquiring bank and acquiring processor).

At step 103, the acquirer seeks authorisation via a card scheme, which is thereafter routed to a processor.

At step 104, if the transaction currency matches one of the set of currencies that are enabled on the card, the process moves on to step 105. Else, the process moves on to step 123.

At step 105, if the balance of the wallet that matches the currency of the transaction is sufficient to fulfil the transaction, the process moves on to step 106. Else, the process moves on to step 109.

At step 106, the relevant value is debited from the transaction currency wallet.

At step 107, the value is blocked.

At step 108, a successful authorisation response is returned to the card scheme (and therefore onward to the acquirer/merchant). The authorisation transaction is then complete.

If, at step 105, the balance of the wallet that matches the currency of the transaction is not sufficient to fulfil the transaction, the process moves on to step 109 where the processor determines the currency order list that can be set by the programme manager, customer, alphabetically, randomly, etc.

At step 110, the processor selects the first (or next) wallet on the list. This step starts a loop that can check, up to, all the currency wallets available for the card.

At step 111, for the next wallet on the list, the processor uses a currency rate table determined by the programme manager and/or card scheme to convert the value of that wallet into that of the transaction currency.

At step 112, the processor calculates the combined balance of the transaction currency wallet and the converted balance (at step 111).

At step 113, the processor determines if the combined balance is sufficient to fulfil the transaction. If the combined balance is equal to or greater than the transaction value, the process moves on to step 114. Else, the process moves on to step 120.

At step 114, the relevant value is debited from the non-transaction currency wallet and credited into the transaction currency wallet.

At step 115, the transaction value is debited from the transaction currency wallet.

At step 116, the transaction value is blocked.

At step 117, the processor sends a successful authorisation response to the card scheme (and therefore onward to the acquirer/merchant).

At step 118, the processor sends notification of the transaction(s) and currency conversion(s) (value and rate) to the programme manager platform using an outgoing authorisation mechanism (or any other messaging mechanism) between the processor and programme manager. Alternatively, the processor may send just the base currency value or just the transaction currency value, with the relevant calculation then performed by the programme manager.

At step 119, the programme manager sends an outbound message to an FX (foreign exchange) liquidity provider to enable opening of the currency exchange position(s). Alternatively, the programme manager may open the position(s) at another time. The authorisation of the transaction is then complete and the process ends.

If at step 113, the combined balance is not sufficient to fulfil the transaction, the process moves on to step 120, where the entire balance is debited from the non-transaction currency wallet and the resultant (converted to the transaction currency) value is credited to the transaction currency wallet.

At step 121, the processor determines if there are any more currency wallets on the list. If there is another currency wallet available, the loop returns to step 110 to select the next currency wallet on the list. If there are no more currency wallets on the list, the process moves on to step 122.

At step 122, a new loop is run over each non-transaction currency wallet that was debited in the previous loop. This loop effectively reverses the loop that credits the transaction currency wallet from the non-transaction currency wallet(s) so that the balance of each of the non-transaction wallets returns to the balance prior to the start of the transaction process. The process moves on to step 127.

At step 127, the equivalent value, in the transaction currency, to return the balance in the non-transaction currency wallet is debited from the transaction currency wallet.

At step 128, the value, in the non-transaction currency, is credited to the balance in the relevant non-transaction currency wallet.

At step 129, if there are any non-transaction currency wallets remaining that requires its balance to return to the balance prior to the beginning of the transaction, the loop is repeated and moves to step 122 for the next non-transaction currency wallet that was debited in the previous loop. If the balances of all the non-transaction currency wallets have been returned to the value prior to the start of the transaction, the process moves on to step 130.

At step 130, the authorisation is rejected and a decline response is sent to the card scheme (and therefore onward to the acquirer/merchant). The process then ends.

If at step 104, the transaction currency does not match one of the set of currencies that are enabled on the card, the process moves on to step 123, where the processor uses the card scheme-converted rate (converted to the base currency of the card) and carries out a standard authorisation against the base currency.

At step 124, the processor determines if the available balance in the base currency wallet is sufficient to carry out the transaction. If the available balance is sufficient, the process moves on to step 125. If the available balance is not sufficient, the process moves on to step 127, where the authorisation is rejected and a decline response is sent to the card scheme (and therefore onward to the acquirer/merchant) and the process then ends.

At step 125, the relevant value in the base currency wallet is blocked.

At step 126, the relevant value is debited from the base currency wallet

At step 127, a successful authorisation response is returned to the card scheme (and therefore onward to the acquirer/merchant). The process then ends.

As shown in FIG. 1, the loop in steps 110-113, 120, 121 can lead to a single transaction involving many FX calculations and transactions, especially if the transaction value is large and/or the balance in each of the wallets is low. This process is resource-intensive, time-consuming, increases the risk of errors and can lead to an increase in network traffic. Furthermore, increasing the number of FX conversions that are required leads to an increasing total cost from the FX conversions to the cardholder. Therefore, there is a need to provide a process that is more cost and resource efficient and reduces the required processing time and network resources.

Furthermore, when a cardholder credits funds across multiple currencies, the cardholder is exposed to, and takes the risk of, foreign exchange fluctuations across these various currencies. For example, if a US cardholder loads their card in AUD currency (at the prevailing rate on the day), then over time, the USD equivalent of this AUD currency may be less than, or more than, the original USD amount. Therefore, there is also a need to reduce a cardholder's exposure to currency fluctuations.

According to a first aspect there is provided a method for maintaining a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the method comprising the step of: inhibiting the crediting of the balance of a subset of the wallets associated with the plurality of currencies such that the balance for each of said subset of wallets is less than or equal to a predetermined amount irrespective of the currency of credit credited to the multicurrency card.

Suitably, the method comprises inhibiting the crediting of the balance of said subset of wallets such that the multicurrency card maintains a debitable balance in a single currency or a subset of the currencies.

Suitably, the predetermined amount is zero.

Suitably, the inhibiting step comprises preventing crediting of the multicurrency card in any currency other than the single currency.

Suitably, the inhibiting step comprises the steps of: crediting the multicurrency card in one of the plurality of currencies; converting, in dependence on a currency exchange rate, the said credited amount into an amount in said single currency if said credited amount is in a currency different to the single currency; and crediting said converted amount into the wallet associated with the said single currency.

Suitably, the processing scheme is configured such that, by default, the wallet associated with a transaction currency is debited for a transaction.

Suitably, debiting comprises converting the value of the transaction into a value in the transaction currency in dependence on the currency exchange rate.

Suitably, the processing scheme is configured so as to utilise a scheme currency exchange rate, the method further comprising the steps of: determining a currency exchange rate; and accessing said determined rate.

Suitably, the method further comprises the steps of, for a transaction in a currency other than the single currency: converting the value of the transaction into a value in the single currency; debiting said converted value from the wallet associated with the single currency; and crediting a wallet associated with the transaction currency with said converted value in the transaction currency.

According to a second aspect, there is provided a method for maintaining a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the method comprising the step of: intermittently transferring credit from a subset of the wallets associated with the plurality of currency wallets such that the remaining balance for each of the wallets of said subset is less than or equal to a predetermined amount.

Suitably, the step of transferring credit is performed in accordance with a predetermined schedule.

Suitably, the credit is transferred such that the multicurrency card maintains a debitable balance in only a single currency.

Suitably, the subset of wallets is all but one of the plurality of wallets associated with the plurality of currencies.

According to a third aspect there is provided a system for a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the system comprising: a maintenance processor configured to constrain the balance of a subset of the wallets associated with the plurality of currencies such that the balance for each of said subset of wallets is less than or equal to a predetermined amount irrespective of the currency of credit credited to the multicurrency card.

Suitably, the maintenance processor is configured such that the multicurrency card maintains a debitable balance in a single currency or a subset of the currencies.

Suitably, the predetermined amount is zero.

Suitably, the system is configured to prevent crediting of the multicurrency card in any currency other than the single currency.

Suitably, the maintenance processor is further configured to: credit the multicurrency card in one of the plurality of currencies; convert, in dependence on a currency exchange rate, the said credited amount into an amount in said single currency if said credited amount is in a currency different to the single currency; and credit said converted amount into the wallet associated with the said single currency.

Suitably, the system further comprises a scheme processor configured to process transactions in accordance with the processing scheme, the scheme processor being configured such that, by default, the wallet associated with the transaction currency being debited for any transaction.

Suitably, the scheme processor is configured to, when debiting, convert the value of the transaction into a value in the said single currency in dependence on a currency exchange rate.

Suitably, the scheme processor is configured to read scheme currency exchange rates and the maintenance processor is configured to determine a currency exchange rate and send said determined rate such that the scheme processor stores or accesses in real-time the said determined rate.

Suitably, the system further comprises a transaction processor configured to: receive a request for a transaction in a currency other than the single currency; convert the value of the transaction into a value in the said single currency; debit said converted value from the wallet associated with the single currency; credit a wallet associated with the transaction currency with said converted value in the transaction currency.

Suitably, the system further comprises: a network; an acquiring processor connected to the network and configured to send, via the network, a request to process a transaction to a transaction processor; and a currency exchange provider, which may also be MasterCard®, Visa® or another card provider, connected to the network for providing a base currency exchange rate, wherein the transaction processor is configured to determine the currency exchange rate for converting the transaction value from the transaction currency to the single currency in dependence on the base currency exchange rate.

Suitably, the transaction processor is configured to send a notification message to the maintenance processor and/or programme manager, the notification message comprising transaction value and the corresponding currency exchange rate.

Suitably, the maintenance processor and/or programme manager are configured to send a FX message via the network to currency exchange provider, said FX message comprising a request to open a currency exchange position, or the FX message/transaction may be stored by the maintenance and/or scheme processor and/or programme manager and the FX transaction can be executed at a later date with the currency exchange provider and/or MasterCard®, Visa® or another card provider.

According to a third aspect, there is provided a system for a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the system comprising: a maintenance process configured to intermittently transfer credit from a subset of the wallets associated with the plurality of currency wallets such that the remaining balance for each of said subset of wallets is less than or equal to a predetermined amount.

Suitably, the maintenance processor is configured to transfer the credit in accordance with a predetermined schedule.

Suitably, the credit is transferred such that the multicurrency card maintains a debitable balance in only a single currency.

Suitably, the subset of wallets is all but one of the plurality of wallets associated with the plurality of currencies.

A method of the present invention may be performed by means of a data processor configured to execute software code. The software code may be stored in non-transient form in memory accessible to the processor.

The present invention will now be described by way of example with reference to the accompanying drawings, in which:

FIG. 1 shows a standard process for processing a transaction on a multicurrency card;

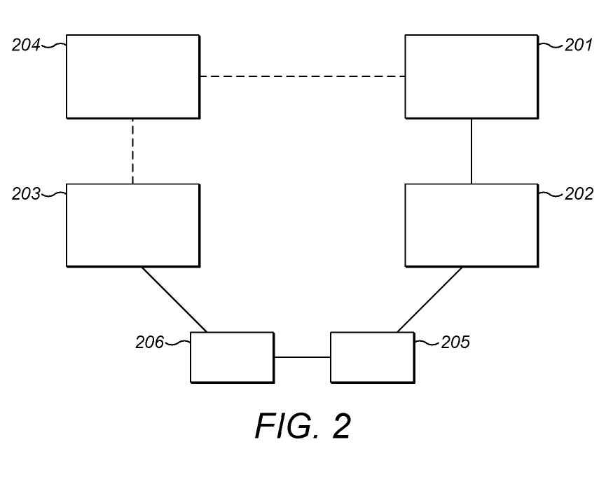

FIG. 2 shows a system in which a transaction on a multicurrency card can be processed; and

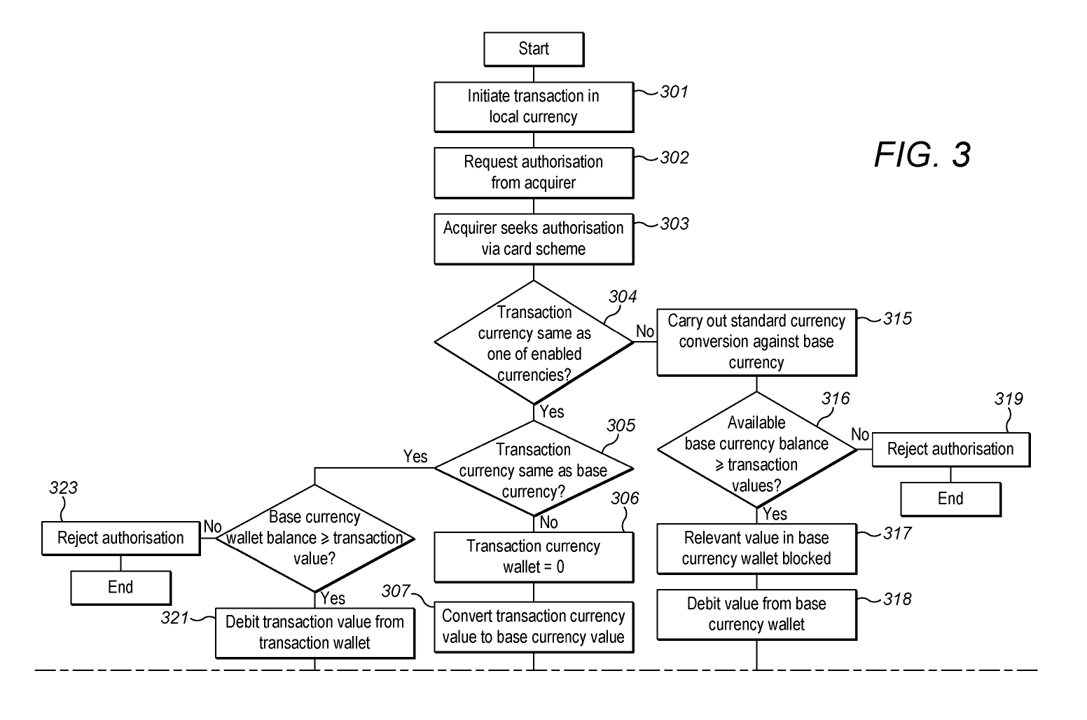

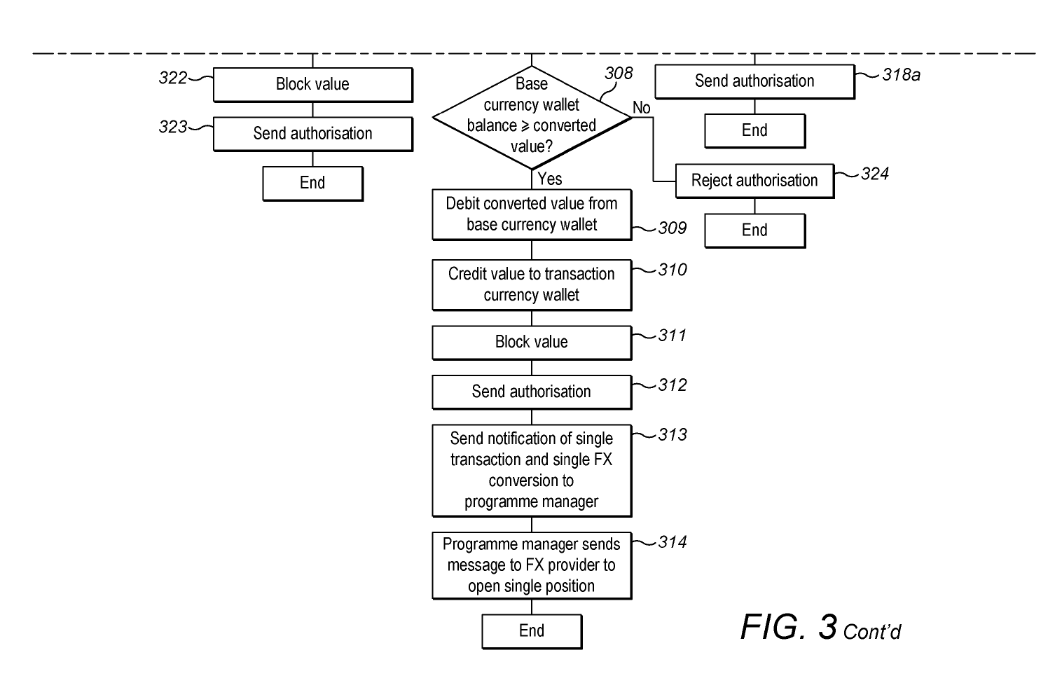

FIG. 3 shows an improved process for processing a transaction on a multicurrency card.

FIG. 2 depicts a system for processing a transaction using a multicurrency card. The system comprises an acquirer terminal 201, which may be a computer or a handheld device that is connected to a network, such as the internet. The acquirer terminal 201 may be capable of reading (e.g. electronically via an RFID or magnetic strip reader, or using Near Field Communications) and/or receiving (e.g. via user input) the details of a multicurrency card. The acquirer terminal 201 can communicate with an acquirer 202 to send the card details, the transaction amount and the merchant identification. The acquirer 202 has a relationship with the merchant (and typically supplies the acquirer terminal devices), and provides the merchant account to which payments are made. The acquirer 202 may be a bank or financial institution that processes card payments for the merchant and acquires payment via a card scheme or card association. The card provider, such as Visa® or MasterCard®, sets the rules for processing the transaction and acts as a switch/router between the acquirer 202 and the issuer 203 of the multicurrency card and facilitates the electronic transfer of funds between the acquirer 202 and the issuer 203. The issuer 203 is the bank or financial institution that issues the multicurrency card to the cardholder 204. The issuer 203 can manage aspects of the card and allows the cardholder 204 to credit the card.

The processing of the transaction between the acquirer 202 and the issuer 203 involves a processor 205, such a computer, which processes the transaction according to the rules and procedures set by the card scheme. The processor 205 authorises transactions, stores card balances and FX tables to perform the authorisations. A programme manager 206 can provide coordination and control of various parameters for the issuer 203 and the processor 205.

For the purpose of this description, the acquirer 202, issuer 203, and processor 204 and programme manager 206 are treated as discrete entities. However, it should be understood that a single organisation or a smaller number of organisations/entities may provide those functions/services.

The programme manager is capable of managing the multicurrency card on behalf of the issuer. The present disclosure describes a method of managing and maintaining a multicurrency card that allows transactions to be completed in a more efficient manner within the processing structure that is required by the card schemes. The programme manager is capable of maintaining a multicurrency card so that the majority or the total balance on the card is held in a single currency (i.e. in a single wallet). Typically, this currency or wallet will be the base currency or base wallet. The programme manager processes any credit that is added to the multicurrency card so that each of the foreign currency wallets (i.e. all wallets other than the base wallet) maintains a balance that does not exceed a predetermined amount. The predetermined amount may be set by the programme manager, for example. The predetermined amount may be an amount that, for example, minimises cost of converting the base currency into a foreign currency when crediting foreign currency wallets of the multicurrency card. Preferentially, the predetermined amount may be equivalent to, for example, 5 USD, or more preferentially 2 USD or even more preferentially 1 USD or even more preferentially zero. Different predetermined amounts may apply to each of the foreign currency wallets. If any foreign currency is credited to the multicurrency card, the programme manager can convert the relevant foreign currency amount into a base currency amount and credit that amount to the base currency wallet. This conversion may happen when the foreign currency credit is applied or at some predetermined time later. For example, any balance in foreign currency wallet balance may be transferred periodically (e.g. hourly, daily, etc.) to the base currency wallet. In another example, the balance in the foreign currency wallet may be transferred if it reaches a value greater than a threshold value (e.g. the predetermined amount). Thus the programme manager can constrain all but one of the wallets (typically, each of the foreign exchange wallets) to a balance that is less than or equal to a predetermined amount. When the predetermined amount(s) is/are set to a trivial level (e.g. 2 USD) this will typically cause the multicurrency card to maintain a majority or total (if the predetermined amount is zero) balance in a single currency (typically, the base currency).

No currency conversion is required if the multicurrency card is credited in the base currency. Maintaining a majority or total balance in the base currency also reduces the exposure to foreign exchange rate fluctuations for the cardholder as the multicurrency card is credited in the domestic currency.

By maintaining only a single currency balance (in one wallet) in the multicurrency card the balance check loop in the transaction processing for the card (as described by steps 110-113, 120-129 in FIG. 1) is not performed, thus reducing overall average authorisation time and required resources at the processor. This is further illustrated in FIG. 3, which depicts how constraining the foreign exchange wallets to, for example, a zero balance can provide an improved and more efficient process for a processor to process transactions for a multicurrency card. These benefits can also be achieved by maintaining the balance in a subset of wallets, wherein the number of wallets in the subset of wallets is less than the total number of available wallets. Reducing the number of wallets in the subset of wallets reduces the processing required in the balance check loop, with the greatest reduction in the processing achieved when the number wallets in the subset of wallets is one. The examples described herein are described with reference to a single wallet. However, the examples can also be applied to maintaining the balance in a number of wallets that is greater than one and less than the total number of available wallets.

The order of some of the steps in the process below may be changed without affecting the result achieved by the process.

At step 301, the transaction is initiated at a point-of-sale (POS) terminal in the local, transaction currency of the merchant or acquiring bank.

At step 302, the POS terminal requests authorisation from a relevant acquirer (typically the acquiring bank and acquiring processor).

At step 303, the acquirer seeks authorisation via a card scheme, which is thereafter routed to the processor.

At step 304, if the transaction currency matches one of the set of currencies that are enabled on the card, the process moves on to step 305. Else, the process moves on to step 315.

At step 305, if the transaction currency is the same as the base currency, the process moves on to step 320. If the transaction currency is different to the base currency, the process moves on to step 306.

At step 306 and, indeed throughout the process, the processor and/or programme manager can constrain the balance of the foreign currency wallets to zero so that the balance of the wallet that matches the currency of the transaction can be held at zero.

At step 307, the processor converts the transaction value into that of the base currency. This is the only FX calculation that the processor is required to perform. If the foreign currency wallets were not constrained to zero, more than one FX calculation may be required. Therefore, the required resources and processing time for carrying out the FX calculation is reduced.

At step 308, if the available base currency wallet balance is equal to or greater than the calculated value of the transaction in the base currency, the process moves on to step 309. If the available base currency wallet balance is less than the calculated value of the transaction in the base currency, the process moves on to step 324, where the authorisation is rejected and a decline response is sent to the card scheme (and therefore onward to the acquirer/merchant).

At step 309, the relevant calculated value is debited from the base currency wallet.

At step 310, the relevant value is credited to the transaction currency wallet. As there is only one wallet from which the transaction currency wallet is credited from, the processor is not required to carry out any addition calculations, which would be required if the foreign currency wallets were not constrained to, in this example, zero and the balance check loop was required to be performed. Thus, by constraining the foreign currency wallets to zero so that only a single currency balance is maintained on the multicurrency card, the processor is not required to perform any balance addition calculations, thus reducing the required processing resources and time. Furthermore, the processor is not required to maintain an aggregated, calculated balance in memory during the loop and therefore the risk of having to restart the whole calculation in case of a memory error or system failure is reduced.

At step 311, the transaction value is blocked.

At step 312, the processor sends a successful authorisation response to the card scheme (and therefore onward to the acquirer/merchant).

At step 313, the processor sends notification of the single transaction and currency conversion (value and rate) to the programme manager platform using an outgoing authorisation mechanism (or any other messaging mechanism) between the processor and programme manager. Alternatively, the processor may send just the base currency value or just the transaction currency value, with the relevant calculation then performed by the programme manager. Alternatively, the processor may store the transaction for reporting or settlement at a later time/date with the issuer or programme manager or card provider. Thus, in this example, by maintaining a single currency balance, only a single transaction and currency conversion is carried out by the processor or programme manager. This leads to the required resources and processing time by the processor/programme manager to be reduced as compared to having more than one transaction and currency conversion which can occur if the balance of the foreign exchange wallets were not constrained to zero.

At step 314, the programme manager (or the processor) sends an outbound message to an FX liquidity provider (defined as any entity able to provide FX buying and/or selling services, and could also be the card provider) to enable opening of the single currency exchange position. Alternatively, the programme manager may open the position at another time, or aggregate the positions for settlement at another time. The authorisation of the transaction is then complete and the process ends. By constraining the balance of the foreign currency wallets, the transaction process involves only a single outbound message to the FX liquidity provider, as opposed to up to the number of currencies available on the card. This reduces network traffic between the programme manager and the FX liquidity provider and also reduces the required resources and processing time at the programme manager and the FX liquidity provider. Furthermore, as only one FX position is opened with the FX liquidity provider, the end-of-day settlement process is simplified and, consequently, reduces network traffic, required resources and processing time for the FX liquidity provider and the programme manager.

If at step 304, the transaction currency does not match one of the set of currencies that are enabled on the card, the process moves on to step 315, where the processor uses the card scheme-conversion rate, which may be set by the card provider (converted to the base currency of the card) and carries out a standard authorisation against the base currency.

At step 316, the processor determines if the available balance in the base currency wallet is sufficient to carry out the transaction. If the available balance is sufficient, the process moves on to step 317. If the available balance is not sufficient, the process moves on to step 319, where the authorisation is rejected and a decline response is sent to the card scheme (and therefore onward to the acquirer/merchant) and the process then ends.

At step 317, the relevant value in the base currency wallet is blocked.

At step 318, the relevant value is debited from the base currency wallet

At step 318a, a successful authorisation response is returned to the card scheme (and therefore onward to the acquirer/merchant). The process then ends.

At step 320, if the balance of the base currency wallet is sufficient to fulfil the transaction, the process moves on to step 321. Else, the process moves on to step 323, where the authorisation is rejected and a decline response is sent to the card scheme (and therefore onward to the acquirer/merchant) and the process then end.

At step 321, the transaction value is debited from the base currency wallet.

At step 322, the value is blocked.

At step 323, a successful authorisation response is returned to the card scheme (and therefore onward to the acquirer/merchant). The authorisation transaction is then complete.

Thus, as shown by the processes of FIGS. 1 and 3, by constraining the wallets in currencies other than the base currency to zero, the system for processing a transaction can be made to be more efficient as the balance check loop is not required to be carried out and only a single foreign exchange calculation and conversion is required. The constraining of the wallets in other than the base currency to be no greater than a predetermined amount may be manifested in various ways. First, the account mechanism underlying the card may be managed in a way that permits credits to be directed to the non-base-currency wallets, but that causes any credits directed to those wallets to be applied directly to the base currency wallet and not to the non-base-currency wallets. Second, the account mechanism underlying the card may be managed in a way that does not permit credits to be directed to the non-base-currency wallets. Other management mechanisms are possible: for example setting a debit limit of zero on the non-base-currency wallets, as well as completely obfuscating the existence of the non-base-currency wallets, effectively rendering them invisible to the customers.

The currency exchange rate utilised by the processor during the transaction process may be stored in a table by the processor, or may be obtained in real-time. Typically, the exchange rate data used by the processor can be provided by the card scheme. Such rates may or may not be favourable to the cardholder or the issuer or any third parties managing the transaction process for the multicurrency card. The programme manager, processor, issuer, FX liquidity provider, card provider, or any other third party can determine currency exchange rates and send or push those rates to the processor. The rates can be periodically determined and pushed to the processor. The processor can receive new pushed data and store that data in place of any old or previous exchange rate data or use the data in real-time. Thus, the exchange rate data can be provided in real-time and/or kept up to date.

The exchange rates may be set so as to minimise the cost of currency conversion during the transaction process. In the transaction system described above, the FX liquidity provider is used to open an FX position for an approved transaction. The programme manager, issuer, processor or any other third party are capable of periodically (or in real-time) importing spot (or closing) buy and sell or mid-market FX rates from the FX liquidity provider (or any other source). Thus, the relevant FX rate data is available to open FX positions with. The programme manager, issuer, processor or any other third party can use this data to determine rates that are used by the processor during a transaction. For example, the data values imported from the FX liquidity provider can be pushed to the processor such that the cost of the currency conversion is minimised for the cardholder. Alternatively, the programme manager and/or processor may apply an agreed logic to the imported FX data to arrive at consumer FX rate values that is then pushed to the processor. This can allow the processor and/or programme manager to apply a logic to the imported rates so as to, for example, minimise the risk of any currency fluctuations in the time between importing the FX rates and opening an FX position for an approved transaction.

Data processing units described herein (e.g. processor 205) need not be provided as discrete units and represent functionalities that could (a) be combined in any manner, and (b) themselves comprise one or more data processing entities. Data processing units could be provided by any suitable hardware or software functionalities, or combinations of hardware and software functionalities.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1.-10. (canceled)

11. A system for a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the system comprising one or more processors, one or more computer-readable tangible storage devices, and program instructions stored on at least one of the one or more storage devices for execution by at least one of the one or more processors, the combination of said processors and program instructions comprising:
a maintenance processor configured to inhibit the balance of a subset of the wallets associated with the plurality of currencies such that the balance for each of said subset of wallets is less than or equal to a predetermined amount irrespective of the currency of credit credited to the multicurrency card.

12. The system of claim 11, the predetermined amount being zero.

13. The system of claim 11, the maintenance processor being configured such that the multicurrency card maintains a debitable balance in only a single currency.

14. The system according to claim 13, wherein the system is configured to prevent crediting of the multicurrency card in any currency other than the single currency.

15. The system according to claim 13, the maintenance processor being further configured to:
a. credit the multicurrency card in one of the plurality of currencies;
b. convert, in dependence on a currency exchange rate, the said credited amount into an amount in said single currency if said credited amount is in a currency different to the single currency; and
c. credit said converted amount into the wallet associated with the said single currency.

16. The system according to claim 11, further comprising a transaction processor configured to:
receive a request for a transaction in a currency other than the single currency;
convert the value of the transaction into a value in the said single currency;
debit said converted value from the wallet associated with the single currency;
credit a wallet associated with the transaction currency with said converted value in the transaction currency.

17. The system according to claim 16, the maintenance processor being configured to determine a currency exchange rate and the transaction processor being configured to store or access in real-time the said determined rate.

18. The system according to claim 16, further comprising:
a network;
an acquiring processor connected to the network and configured to send, via the network, a request to process the transaction to the transaction processor; and
a currency exchange provider or card provider connected to the network for providing a base currency exchange rate, wherein the transaction processor is configured to determine the currency exchange rate for converting the transaction value from the transaction currency to the single currency in dependence on the base currency exchange rate.

19. The system according to claim 16, wherein the transaction processor is configured to send a notification message to the maintenance processor and/or programme manager, the notification message comprising the transaction value and the corresponding currency exchange rate.

20. The system according to claim 16, the maintenance processor and/or programme manager being configured to send a FX message via the network to a currency exchange provider, said FX message comprising a request to open a currency exchange position.

21. A system for a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the system comprising one or more processors, one or more computer-readable tangible storage devices, and program instructions stored on at least one of the one or more storage devices for execution by at least one of the one or more processors, the combination of said processors and program instructions comprising:
a maintenance processor configured to intermittently transfer credit from a subset of the wallets associated with the plurality of currency wallets such that the remaining balance for each of said subset of wallets is less than or equal to a predetermined amount.

22. The system according to claim 21, wherein the maintenance processor is configured to transfer the credit in accordance with a predetermined schedule.

23. The system according to claim 21, said credit being transferred such that the multicurrency card maintains a debitable balance in only a single currency.

24. The system according to claim 11, wherein the subset of wallets is all but one of the plurality of wallets associated with the plurality of currencies.

25. A method for maintaining a multicurrency card for use with a processing scheme for processing transactions, the multicurrency card being associated with a plurality of currencies, each of the plurality of currencies being associated with a respective wallet capable of representing funds in its respective currency, the processing scheme being configured so as to preferentially debit, for a transaction, the wallet associated with the currency of the transaction, the method comprising the step of:
a processor inhibiting the crediting of the balance of a subset of the wallets associated with the plurality of currencies such that the balance for each of said subset of wallets is less than or equal to a predetermined amount irrespective of the currency of credit credited to the multicurrency card.

26. The method according to claim 25, the predetermined amount being zero.

27. The method of claim 25, comprising the processor inhibiting the crediting of the balance of the subset of wallets such that the multicurrency card maintains a debitable balance in only a single currency.

28. The method according to claim 27, wherein the inhibiting step comprises preventing crediting of the multicurrency card in any currency other than the single currency.

29. The method according to claim 27, wherein the inhibiting step comprises the steps of:
a. the processor crediting the multicurrency card in one of the plurality of currencies;
b. the processor converting, in dependence on a currency exchange rate, the said credited amount into an amount in said single currency if said credited amount is in a currency different to the single currency; and
c. the processor crediting said converted amount into the wallet associated with the said single currency.

30. The method according to claim 27, further comprising the steps of, for a transaction in a currency other than the single currency:
converting the value of the transaction into a value in the single currency;
debiting said converted value from the wallet associated with the single currency; and
crediting a wallet associated with the transaction currency with said converted value in the transaction currency.
